(19) United States
(12) Patent Application Publication
(10) Pub. No.: US 2009/0057442 A1
(43) Pub. Date: Mar. 5, 2009

(54) Fertilizer - Insecticide Sprayer

(76) Inventor: Ngoc Quang Nguyen, Ho Chi Minh City (VN)

Correspondence Address: DONN K. HARMS;PATENT & TRADEMARK LAW CENTER, SUITE 100, 12702 VIA CORTINA, DEL MAR, CA, 92014, US

(21) Appl. No.: 11/918,435

(22) PCT Filed: Jul. 11, 2006
(86) PCT No.: PCT/VN2006/000001

§ 371 Date: Oct. 11, 2007

(30) Foreign Application Priority Data
Aug. 25, 2005 (VN) 1-2005-01197

(51) Int. Cl. A01C 3/00

(52) U.S. Cl. 239/302

(57) ABSTRACT

The invention mentions a fertilizer-insecticide sprayer comprising an air compressor (1) in conjunction with a fertilizer-insecticide pressure container (2) through a roll of air pressure pipe (3) and the fertilizer-insecticide container (2) is hung to such a frame (4) that the container can be turned upside down; a roll of liquid pressure pipe (5) is connected to the container (2) and leads fertilizer-insecticide to a hand spraying device (6) with a spraying lock (6.1). Due to the pressure in the container, the fertilizer-insecticide liquid is taken to the hand spraying device (6). Just opening the lock, the spraying device will spray finely and homogeneously the fertilizer-insecticide solution on the plants due to the pressure of the compressed air until there is no fertilizer-insecticide left in the container.

The invention mentions the fertilizer-insecticide sprayer to protect plants, to prevent and fight epidemics for animals and plants and to treat environmental pollution etc. . .

### Technical Condition of the Invention

Currently the method and fertilizer-insecticide sprayer to tend plants to prevent and fight epidemics for animals and plants, to treat environmental pollution base on the use of pumps with propeller, piston to spray liquid solution or gas by hand or by machine. So, the sprayer must be carried on human body, thus making the direct user so tired, taking much labour, wasting a quantity of fertilizer and insecticide due to the unsprayed fertilizer and insecticide left in the machine and the pipe. The bigger problem is that the direct contact with chemicals in the tiredness state may lead to poison, fire, explosion, electrocution, causing risk to health and human life.

### Technical Nature of the Invention

The purpose of the invention is to recommend the fertilizer-insecticide sprayer to tend plants, to prevent and fight epidemics for animals and plants, to treat environmental pollution, to overcome the above mentioned weak points.

To win the set purpose, the fertilizer-insecticide sprayer under the invention, comprises an air-compressor in conjunction with a fertilizer-insecticide pressure container through air pressure pipe; the fertilizer-insecticide container is hung to such a frame that the container can be turned upside down; a roll of liquid pressure pipe is connected to the container and leads fertilizer-insecticide to hand spraying device with a spraying lock.

### BRIEF DESCRIPTION OF THE FIGURES

FIG. 1/1 is a sketch drawing of the fertilizer-insecticide sprayer under the invention.

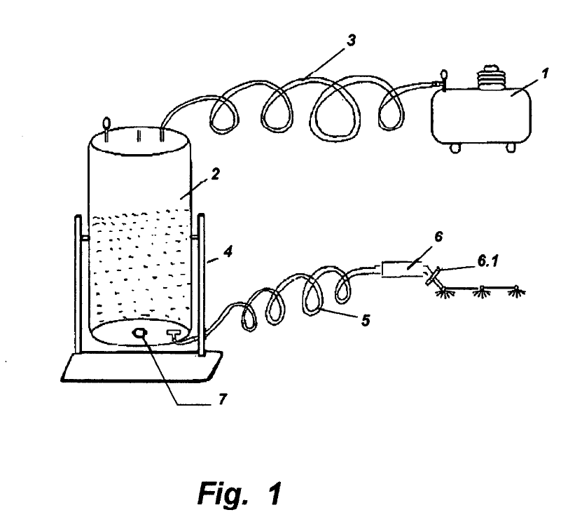

### DETAILED DESCRIPTION OF THE INVENTION

According figure, fertilizer-insecticide sprayer under the invention comprises an air compressor (1) in conjunction with a fertilizer-insecticide pressure container (2) through an air 10 pressure pipe (3) and hung to such a frame (4) that the container can be turned upside down; a roll of liquid pressure pipe (5) is connected to the container (2) and leads fertilizer-insecticide to a hand spraying device (6) with a spraying lock (6.1)

Due to the fact that the container can be turned downside up on the frame (4), so when needing to pour fertilizer-insecticide into the container we need only to reversely turn the container for easy pouring into the opening (7).

When turning on the switch for the air compressor to operate, depending on the area, the volume to be sprayed, we adjust the air pressure through an automatic pressure adjusting relay fixed to the air compressor (1); the air-compressor will pump air into the spraying container (2) until the compressed air reaches the necessary rate (through adjustment and pressure meter), the relay will automatically interrupt the operation of the air compressor. Due to the pressure in the container, the fertilizer-insecticide liquid is taken to the hand spraying device (6); just opening the lock, the spraying device will spray finely and homogeneously the fertilizer-insecticide solution on the plants due to the pressure of compressed air.

The compressor will continuously operate in accordance with the pressure automatically relay until the volume of fertilizer-insecticide solution is completed pushed out of the fertilizer-insecticide sprayer.

Due to steady air pressure for the whole sprayer, and depending on the distance, we can use the length of the roll of air pressure pipe (3) and liquid pressure pipe (5).

When spraying fertilizer-insecticide, the user does not have to carry anything on the shoulder, on the back, but only hold fertilizer-insecticide hand spraying device (6) and goes spraying on the area needing to spray until there is no fertilizer-insecticide left and only air sprayed. Thus the volume of fertilizer-insecticide solution is completely used and the effectiveness can reach 99.99.

1. The fertilizer insecticide sprayer comprises an air compressor in conjunction with the fertilizer-insecticide container through an air pressure pipe and the fertilizer-insecticide container is hung to such a frame that the container can be turned upside down; a roll of liquid pressure pipe is connected to the container and leads fertilizer-insecticide to hand spraying device with a spraying lock.
